(19) United States
(12) Patent Application Publication
(10) Pub. No.: US 2012/0208164 A1
(43) Pub. Date: Aug. 16, 2012

(54) WEB BROWSER BASED TEST CREATION AND ADMINISTRATION SYSTEM

(75) Inventor: Rashid Hoda, Olathe, KS (US)

(73) Assignee: Kansas City, Kansas Unified School District 500, Kansas City, KS (US)

(21) Appl. No.: 13/024,512

(22) Filed: Feb. 10, 2011

(51) Int. Cl. G09B 5/00

(52) U.S. Cl. 434/350

(57) ABSTRACT

A system for creating and administering a computer-based test broadly comprises a test taker component and an administrative component. The test taker component may be executed in a web browser and configured to allow a test taker to request a test, to submit responses to questions of the test, and to view the submitted responses and the correct answers after the test is complete. The administrative component may also be executed in a web browser and configured to allow an administrative user to create the test and to view the responses to questions of the test as the responses are submitted from the test takers.

### BACKGROUND OF THE INVENTION

1. Field of the Invention

Embodiments of the present invention relate to computer-based testing. More particularly, embodiments of the present invention relate to a system and method for computer-based testing that uses a web browser for test creation and administration.

2. Description of the Related Art

Computer-based testing generally allows a test taker to take a test for educational, training, examination, or similar purposes on a computing device. The computing device may include standalone systems such as a desktop computer, portable devices such as a laptop, terminal stations connected to a mainframe, or the like.

### SUMMARY OF THE INVENTION

Embodiments of the present invention provide a distinct advance in the art of computer-based testing systems and methods. More particularly, embodiments of the invention provide a system and method for computer-based testing that uses a web browser for test creation and administration and that provides functionality not found in prior art systems and methods.

One embodiment of the invention broadly comprises system that includes a test taker component and an administrative component. The test taker component may be executed in a web browser and configured to allow a test taker to request a test, to submit responses to questions of the test, and to view the submitted responses and the correct answers after the test is complete. The administrative component may also be executed in a web browser and configured to allow an administrative user to create the test and to view the responses to questions of the test as the responses are submitted from the test takers. The system allows both test takers and administrative users to quickly and easily create, access, take, and administer tests without complicated computer equipment. The system also allows the test taker to complete a test that is interrupted before all of the questions have been answered. The system further allows an administrative user to enter the responses for the test taker to questions from a paper test.

The test responses may be presented in a grid such that a name of each test taker is indicated along one axis and a number of each question is indicated along the orthogonal axis. The response from a test taker to a question may be presented in a grid space at the intersection of the name of the test taker and the number of the question. Furthermore, each grid space may include a first indicia for a correct response and a second indicia for an incorrect response. This allows an administrative user to quickly and easily monitor the progress of the test, spot any problems with the test, and watch for possible copying of answers.

Another embodiment of the present invention may include a method of creating and administering a computer-based test. One embodiment of the method may comprise the steps of creating a test, transmitting the test to a test taker, receiving responses to questions of the test from the test taker, transmitting the submitted responses and the correct answers to the test taker after the test is complete, and presenting to an administrative user the responses to questions of the test as the responses are submitted from the test takers.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a schematic block diagram of a computer-based testing system, constructed in accordance with various embodiments of the present invention;

FIG. 2 is a screen capture of a login screen for test takers;

FIG. 3 is a screen capture of a default screen for test takers;

FIG. 4 is a screen capture of a test question screen for test takers;

FIG. 5 is a screen capture of a test results screen for test takers;

FIG. 6 is a screen capture of a login screen for administrative users;

FIG. 7 is a screen capture of a news screen for administrative users;

FIG. 8 is a screen capture of a user management screen for administrative users;

FIG. 9 is a screen capture of a test standards screen for administrative users;

FIG. 10 is a screen capture of an approved benchmark test names screen for administrative users;

FIG. 11 is a screen capture of a benchmark test approval screen for administrative users;

FIG. 12 is a screen capture of a manage categories screen for administrative users;

FIG. 13 is a screen capture of a manage news screen for administrative users;

FIG. 14 is a screen capture of a news screen for teachers;

FIG. 15 is a screen capture of a create groups screen for administrative users;

FIG. 16 is a screen capture of a manage groups screen for administrative users;

FIG. 17 is a screen capture of a manage banks screen for administrative users;

FIG. 18 is a screen capture of a view banks screen for administrative users;

FIG. 19 is a screen capture of a remove banks screen for administrative users;

FIG. 20 is a screen capture of a create banks screen for administrative users;

FIG. 21 is a screen capture of an add images to a bank screen for administrative users;

FIG. 22 is a screen capture of an insert bank figures screen for administrative users;

FIG. 23 is a screen capture of an add questions screen for administrative users;

FIG. 24 is a screen capture of a test review screen for administrative users;

FIG. 25 is a screen capture of a first create test screen for administrative users;

FIG. 26 is a screen capture of a second create test screen for administrative users;

FIG. 27 is a screen capture of a third create test screen for administrative users;

FIG. 28 is a screen capture of a fourth create test screen for administrative users;

FIG. 29 is a screen capture of a fifth create test screen for administrative users;

FIG. 30 is a screen capture of a sixth create test screen for administrative users;

FIG. 31 is a screen capture of a seventh create test screen for administrative users;

FIG. 32 is a screen capture of an eighth create test screen for administrative users;

FIG. 33 is a screen capture of a ninth create test screen for administrative users;

FIG. 34 is a screen capture of a first manage tests screen for administrative users;

FIG. 35 is a screen capture of a second manage tests screen for administrative users;

FIG. 36 is a screen capture of a remove test screen for administrative users;

FIG. 37 is a screen capture of a first assign test screen for administrative users;

FIG. 38 is a screen capture of a second assign test screen for administrative users;

FIG. 39 is a screen capture of an un-assign test screen for administrative users;

FIG. 40 is a screen capture of a first enter student response screen for administrative users;

FIG. 41 is a screen capture of a second enter student response screen for administrative users;

FIG. 42 is a screen capture of a class grade report screen for administrative users;

FIG. 43 is a screen capture of a test taker grade report screen for administrative users;

FIG. 44 is a screen capture of a test analysis screen for administrative users; and

FIG. 45 is a flow diagram of steps of a method of creating and administering a computer-based test.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

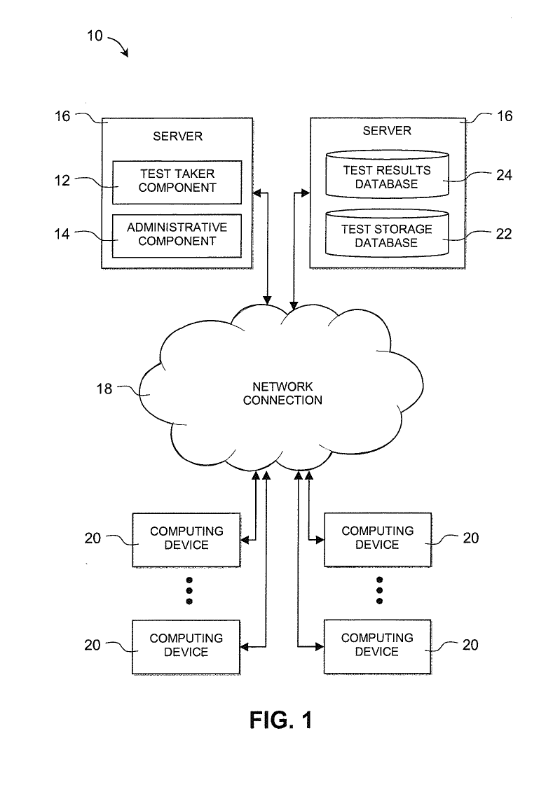

Turning now to FIG. 1, a web-browser based system 10 for creating and administering tests, constructed in accordance with various embodiments of the present invention, broadly comprises a test taker component 12 and an administrative component 14. The system 10 may be implemented in hardware, firmware, software, or combinations thereof, and allows test takers to take tests and administrators to create and manage tests. The system 10 may be installed on one or more servers 16 that are accessible through a network connection 18. The system 10 may be accessed by one or more computing devices 20 coupled to the network connection 18.

In various embodiments, the components of the system 10 may implement software programs or processor-executable code segments that may be stored on a computer-readable storage medium. In the context of this application, a “computer-readable storage medium” can be any device that can contain, or store the program for use by or in connection with the instruction execution system, apparatus, or device. The computer-readable storage medium can be, for example, but not limited to, an electronic, magnetic, optical, electro-magnetic, or semi-conductor system, apparatus, or device. More specific, although not inclusive, examples of the computer-readable storage medium would include the following: a portable computer diskette, a hard drive, a random access memory (RAM), a read-only memory (ROM), an erasable, programmable, read-only memory (EPROM or Flash memory), a portable compact disk read-only memory (CDROM), a digital video disc (DVD), a Blu-Ray™ disc, and the like.

The servers 16 may be any server-type computers or hardware device and may include software or processor-executable code that allows the servers 16 to receive requests for access to the system 10, to retrieve the requested components 12, 14, and to transmit the requested components 12, 14 to the requestor. The servers 16 may include one machine or device, or it may include a plurality of machines or devices in a cabinet or a rack, as known in the art. The servers 16 may also be “virtual” and consist of functionality provided by cloud computing or other distributed computing architectures. The network connection 18 may include a cluster of computing devices in communication with each other and/or with the servers 16, such as a local area network (LAN), a metro area network (MAN), or a wide area network (WAN), and may further include cloud connections, such as the Internet. The network connection 18 may be implemented with a variety of topologies, protocols, and architectures. Furthermore, the network connection 18 may be wired including metal conductive cables, such coax or twisted pair, optical media, such as optical fibers, or combinations thereof. The network connection 18 may also be wireless and may utilize radio frequency (RF) communication standards, such as the Institute of Electrical and Electronics Engineers (IEEE) 802.11 standards.

Each computing device 20 may include standalone systems such as a workstation or desktop computer, portable devices such as a notebook or laptop, terminal stations connected to a mainframe, or the like. Each computing device 20 may further include elements such as a processor, a microprocessor, a microcontroller, or the like. Each computing device 20 may access one of the servers 16 to request the test taker component 12 or the administrative component 14, as appropriate. The servers 16 may transmit the requested component 12, 14 back to the computing device 20, which may then execute the component 12, 14.

The system 10 may further include a test storage database 22 and a test results database 24, both stored on or accessed by one of the servers 16. The test storage database 22 may store tests, banks of questions, figures, standards information, and the like. The test results database 24 may store the results of tests that have been taken. In various embodiments, each answer may be stored in the test results database 24 as the test taker submits the answer. Thus, if there is a problem at the test site, such as a power outage or glitch or the computing device 20 malfunctions, the test results are not lost and may be retrieved as necessary. The test taker component 12 and the administrative component 14 may access both databases 22, 24. The system 10 may also include or access other databases that store information about test takers or administrators.

The test taker component 12 and the administrative component 14 may be created using a markup language, such as hypertext markup language (HTML), and may be enhanced using scripting, such as JavaScript™. The test taker component 12 and the administrative component 14 may be accessed and executed using a web browser, such as Firefox from Mozilla Corporation, Chrome from Google, Inc., Safari from Apple, Inc., and the like.

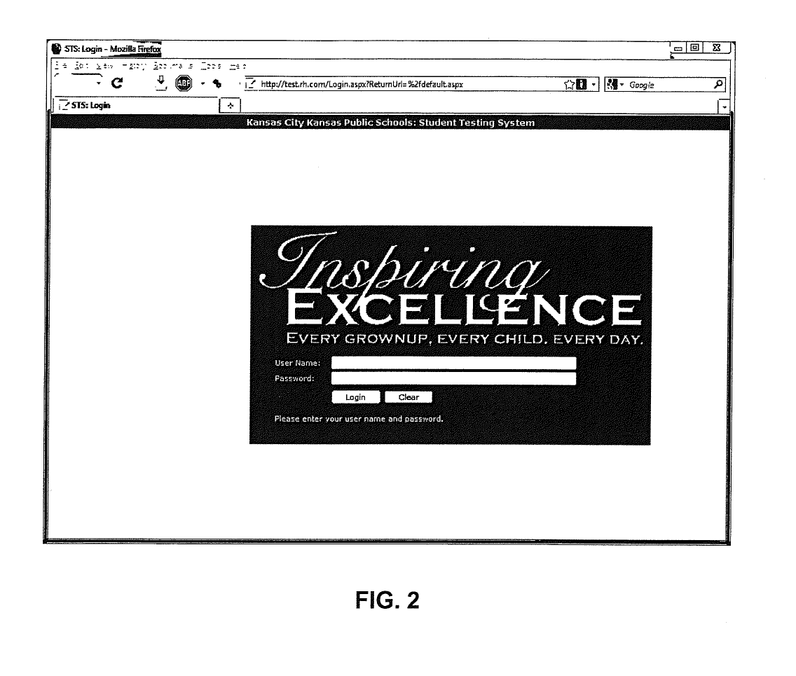

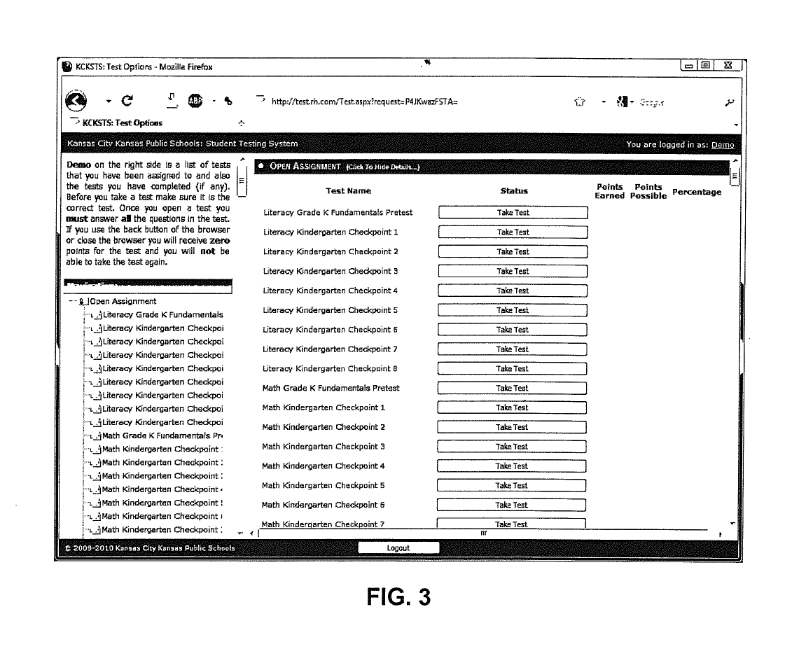

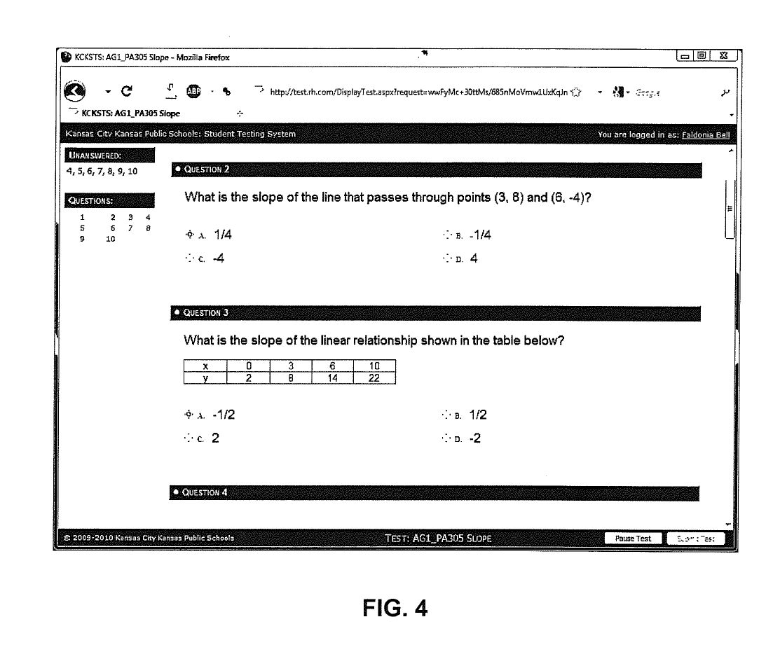

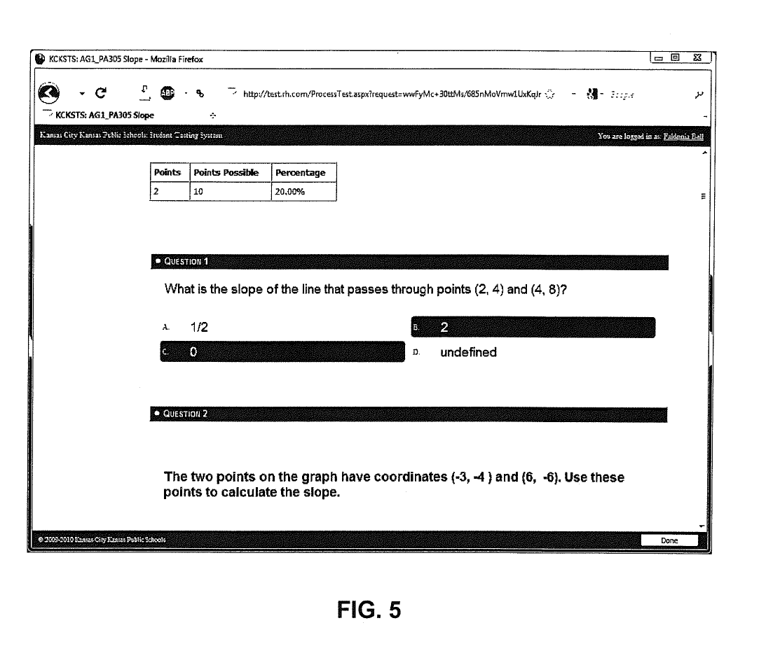

The test taker component 12 is generally executed when a test taker takes a test. The test taker component 12 may include a plurality of features, at least a portion of which are shown in FIGS. 2-5. The test taker may first encounter the login screen, as shown in FIG. 2. After logging in, the test taker may be presented, in FIG. 3, with a list of tests that have been assigned and are available to take. After choosing one of the tests to take, the test taker may be presented with the test questions, as shown in FIG. 4. After the test taker answers all the questions, he may be able to see the results of the test immediately, if the test creator chose test feedback as an option when creating the test. Thus, the test taker can see his answers as well as the correct answers, as shown in FIG. 5. In other embodiments, if test feedback has not been enabled by the test creator, then the test taker may be returned to the list of tests, shown in FIG. 3, when he has completed a test.

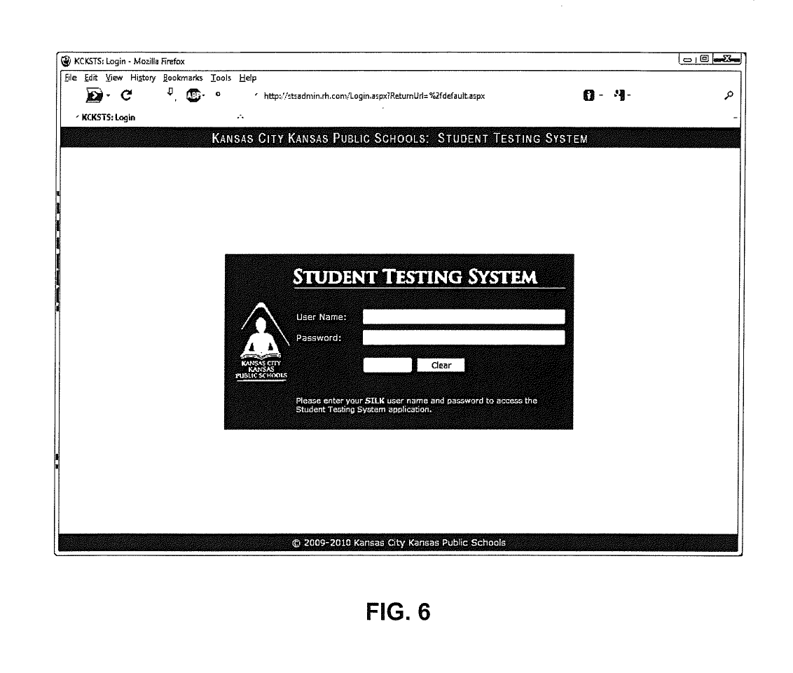

The administrative component 14 may be executed to create test questions, create tests, assign tests, manage student data, and manage administrative user data, among other tasks. There may be three types of administrative users—teachers, managers, and administrators. Teachers may be able to create banks of questions and tests and assign the tests to test takers, such as students, or groups of test takers, such as classes. Teachers may also be able to view reports. Managers may have the abilities of teachers plus the ability to add news items to the main screen (discussed below), approve test names, approve benchmark tests, and manage categories. Administrators may have full control of the administrative component, thereby having the abilities of the teacher and the manager, as well as the ability to manage administrative user data, such as adding and removing administrative users, managing local, state, or national standards, and viewing additional reports. The administrative component 14 may include a plurality of features, at least a portion of which are shown in FIGS. 6-44.

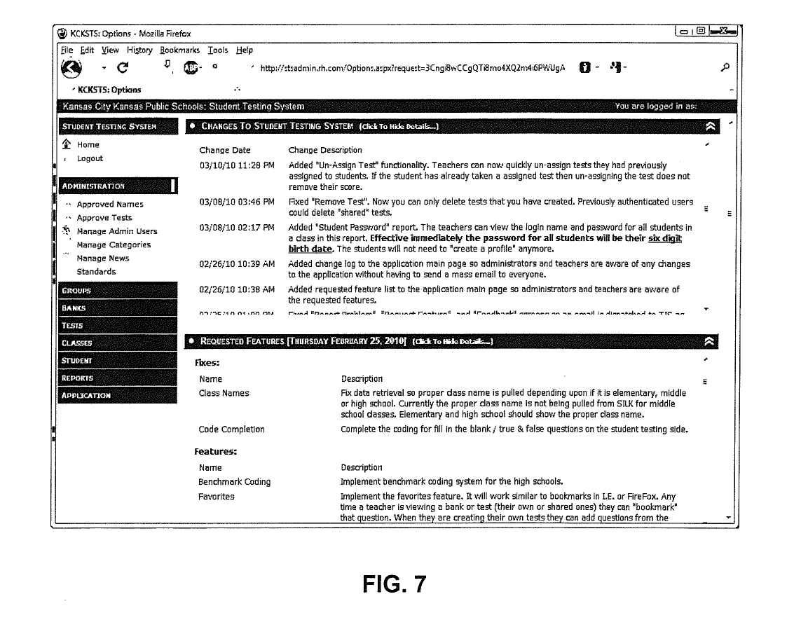

Administrators and managers may first encounter the login screen, as shown in FIG. 6. After logging in, administrators and managers may be presented, in FIG. 7, with an administrator/manager main screen. The main screen may present news items, such as changes to the system 10 and requested features or changes. The main screen may further include a menu, entitled “ADMINISTRATION”, with options for performing various administrator or manager tasks.

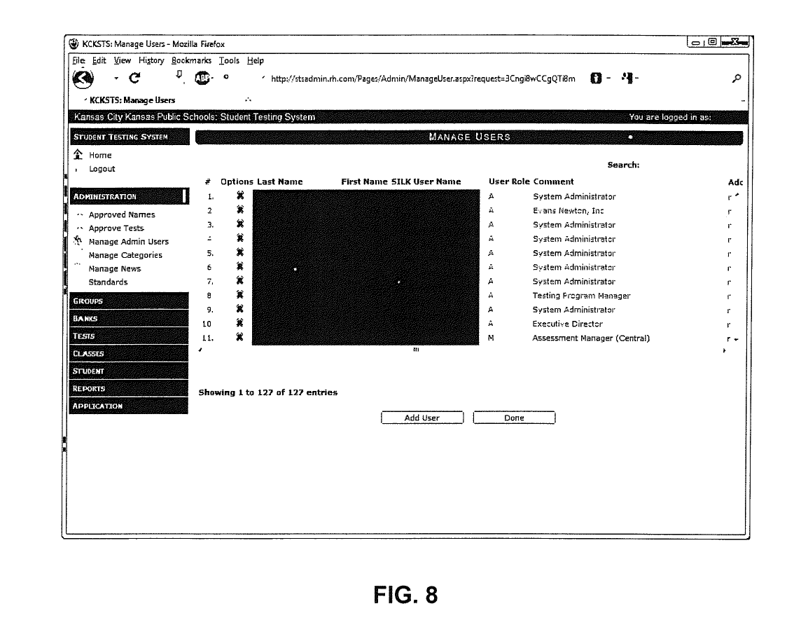

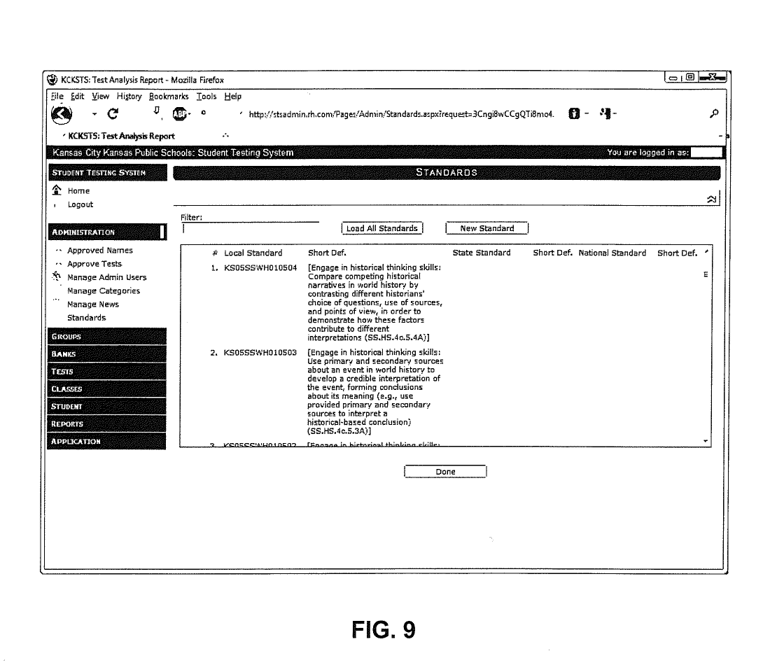

Administrators may manage data regarding administrative users, as shown in FIG. 8. The data may include names, email addresses, roles, comments, and the like. Administrators may have the ability to change any of this information or to remove other users from the system 10. Administrators may also view and edit local, state, or national standards, as shown in FIG. 9, that are stored in the test storage database 22.

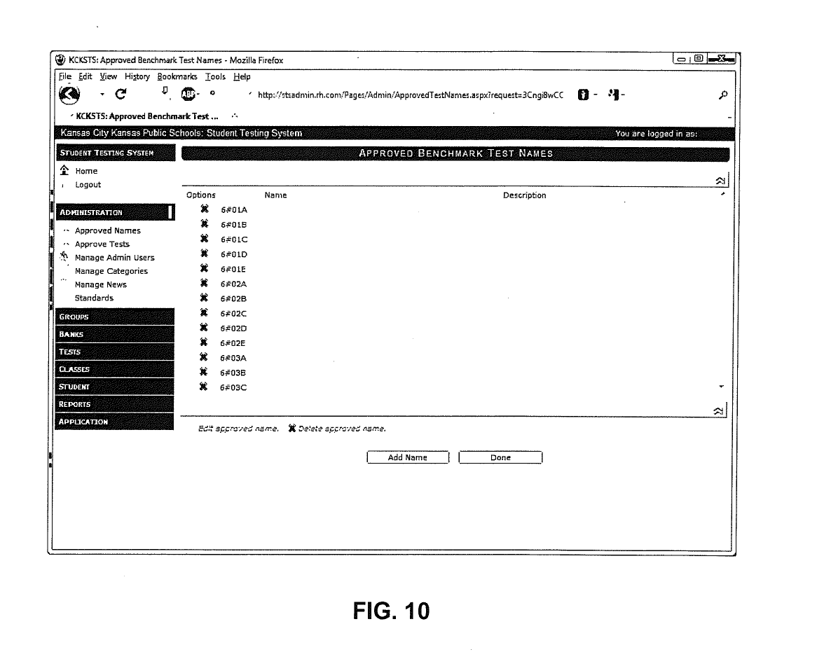

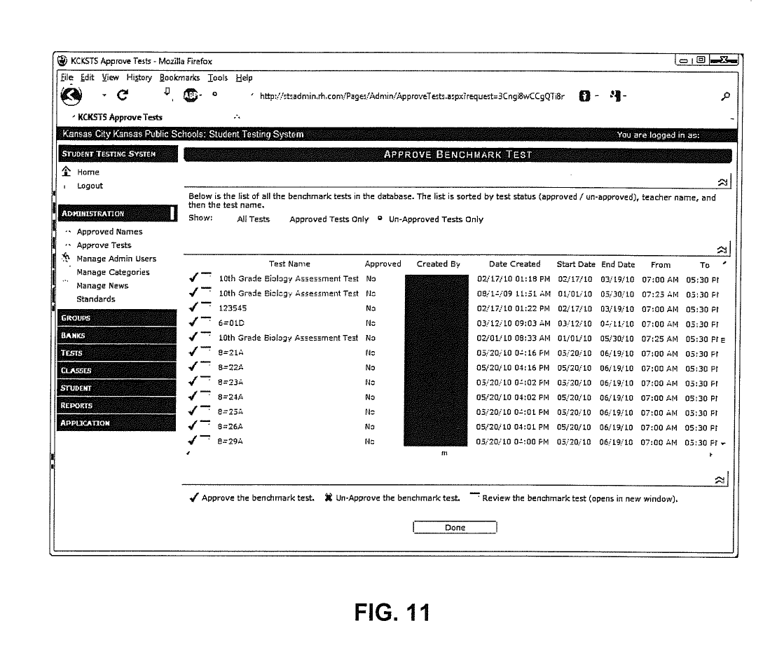

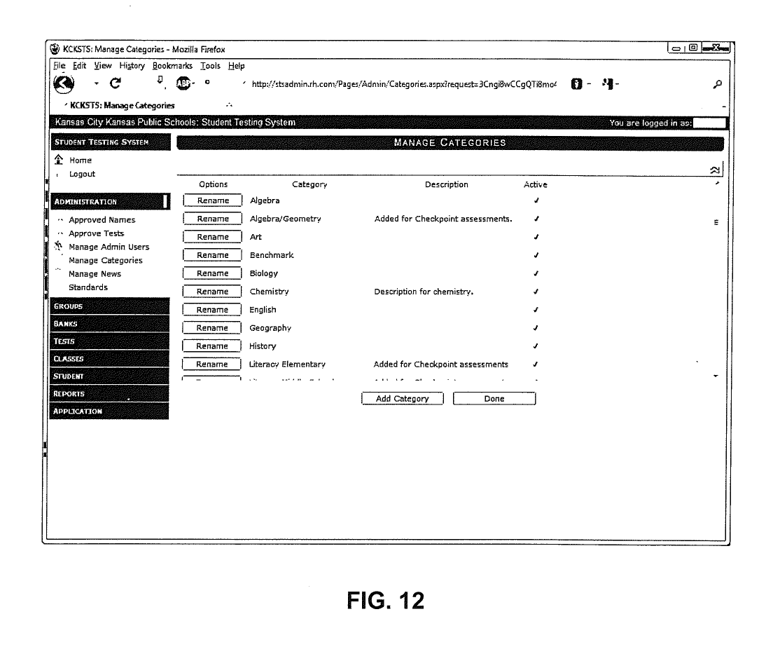

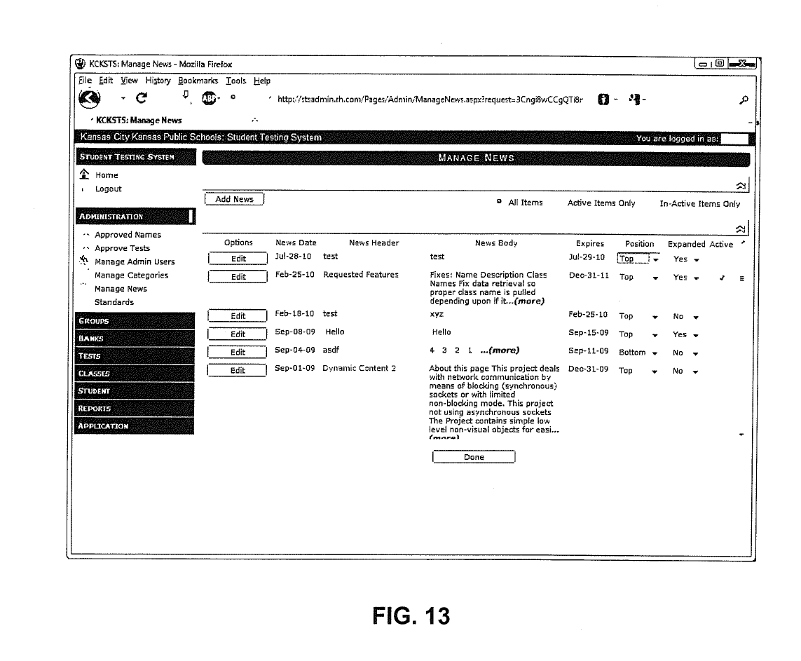

Administrators and managers may approve the names of benchmark tests, as shown in FIG. 10, in order to keep the names of the tests uniform. The benchmark test may test the test taker's knowledge of subject matter as defined and required by local, state, or national standards. Administrators and managers may also review and approve the benchmark tests created by teachers, as shown in FIG. 11. Administrators and managers may further be able to add, edit, or remove test categories, as shown in FIG. 12, from the test storage database 22. In addition, administrators and managers may add or edit news items, as shown in FIG. 13.

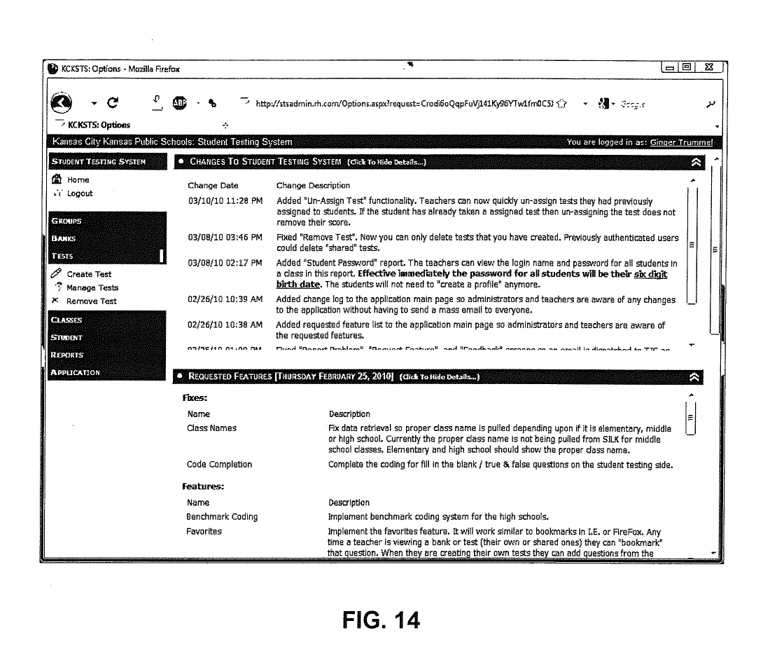

Teachers may be presented with a teacher main screen, as shown in FIG. 14. The teacher main screen may show news items in the same fashion as with the administrator/manager main screen. In addition, the teacher main screen may present a menu with options for performing various tasks. However, the menu on the teacher main screen does not include the options that are limited to administrators and managers. In addition, as mentioned above, all of the options and abilities that are available to teachers are also available to administrators and managers.

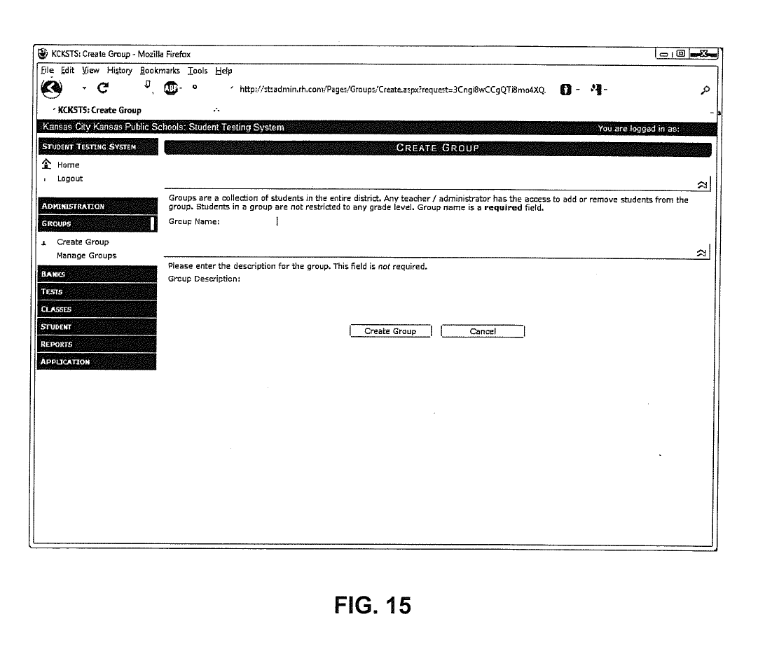

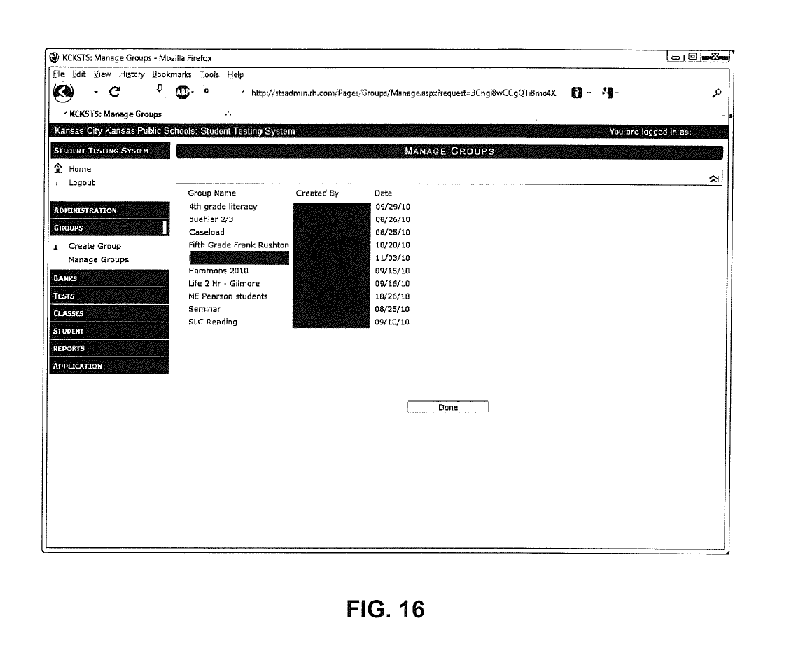

Teachers may create groups of test takers, as shown in FIG. 15. In various embodiments, groups of test takers may exist by default. For example, the test takers may be students who are normally grouped by school, grade level, classroom, etc. However, there may be some situations in which test takers are grouped in different categories, such a math relay group, or a similar academic or competitive group. The screen of FIG. 15 allows teachers to create a group name and add a description. All of the groups created may be viewed in the screen of FIG. 16 and further information may be derived by clicking on any of the names.

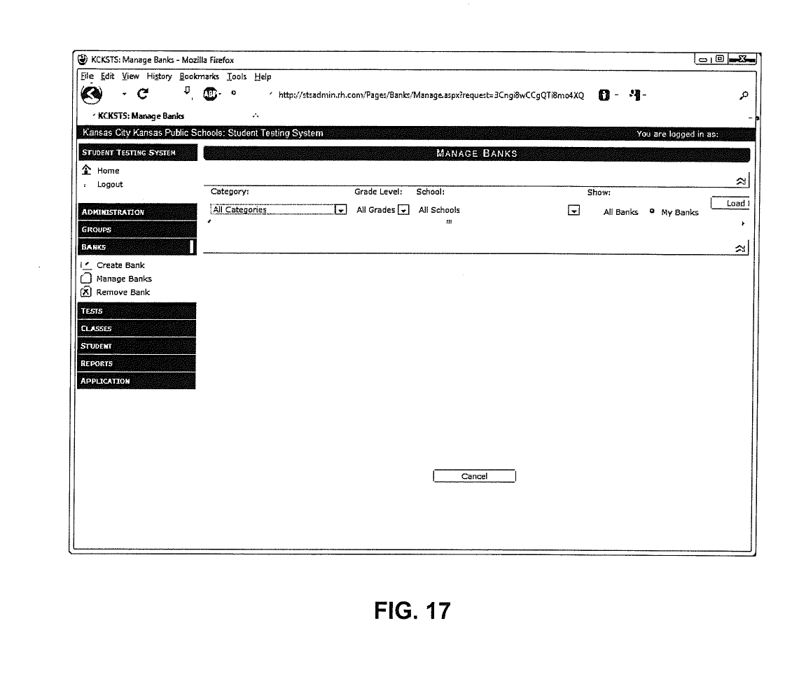

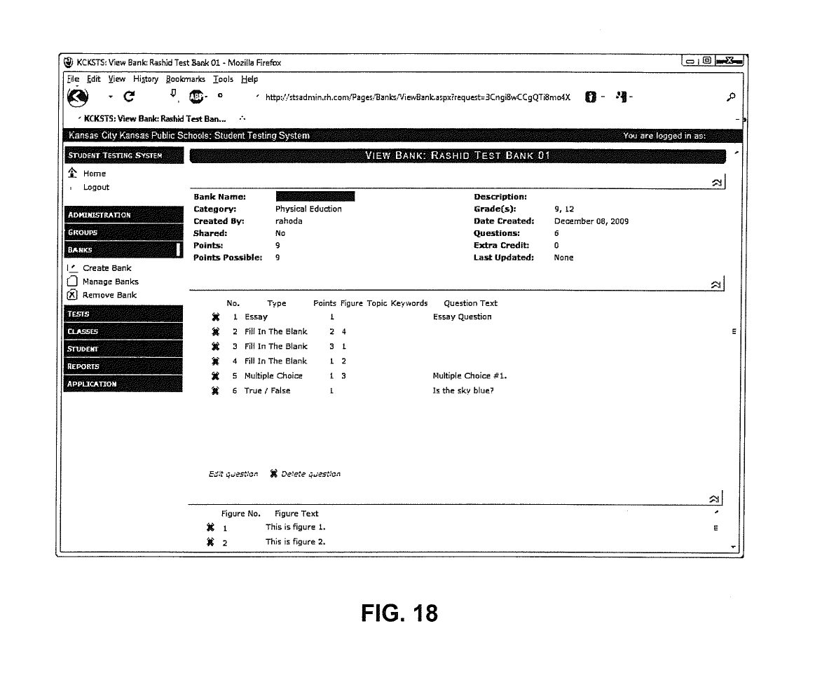

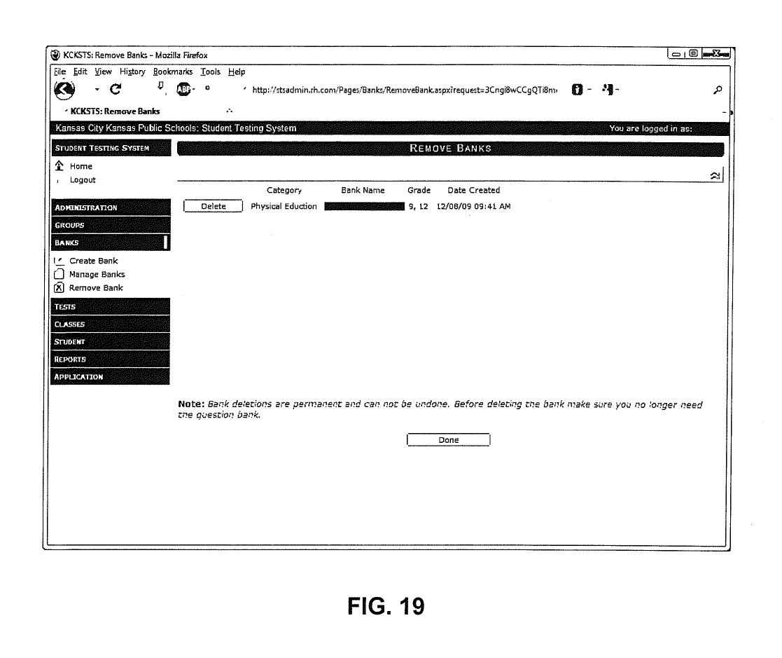

Teachers may also view a list of banks of questions, as shown in FIG. 17. A bank of questions may be a collection of questions that can be used to create a test. A bank may not be assigned to a test taker directly. An individual bank of questions may be viewed by clicking on any one of the banks in the list, which presents the screen shown in FIG. 18. If necessary, teachers may remove one or more banks of questions, as shown in FIG. 19.

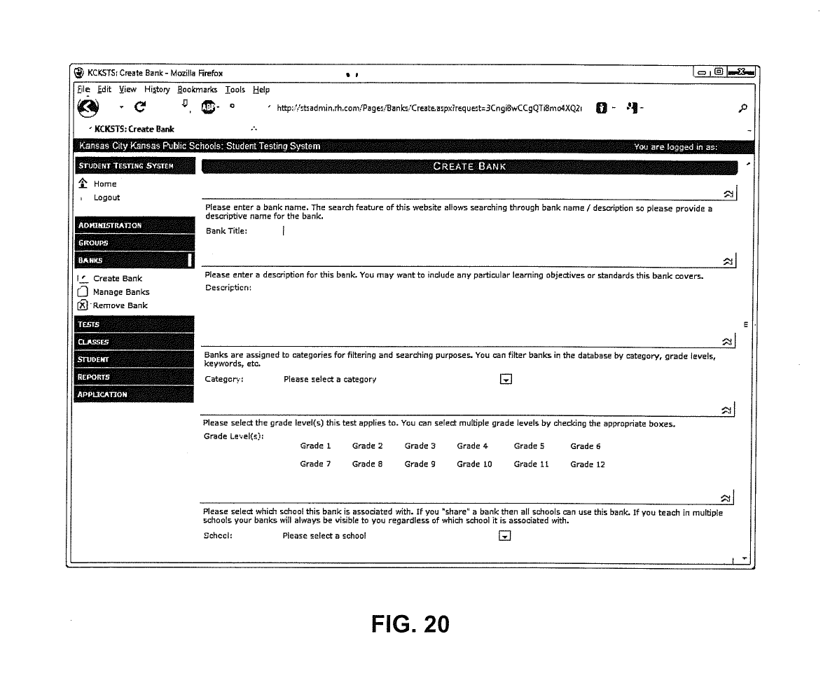

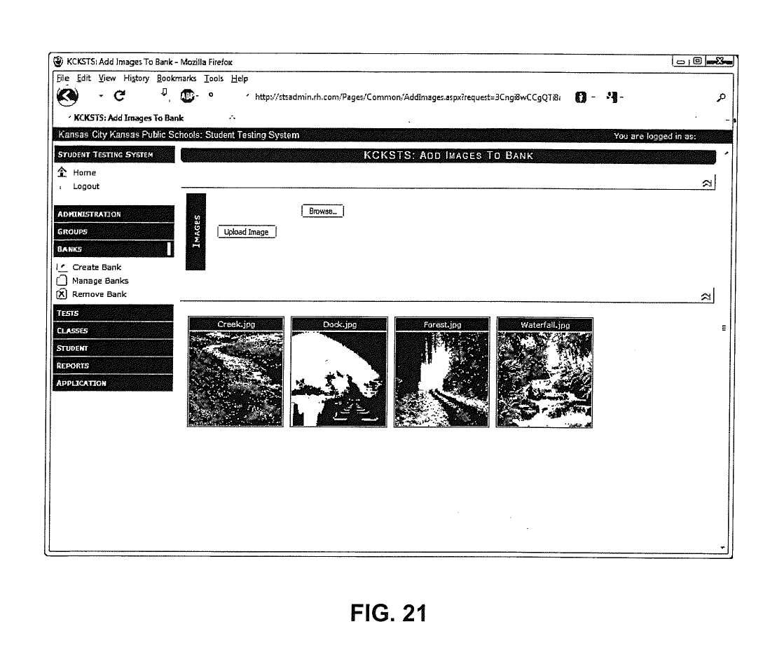

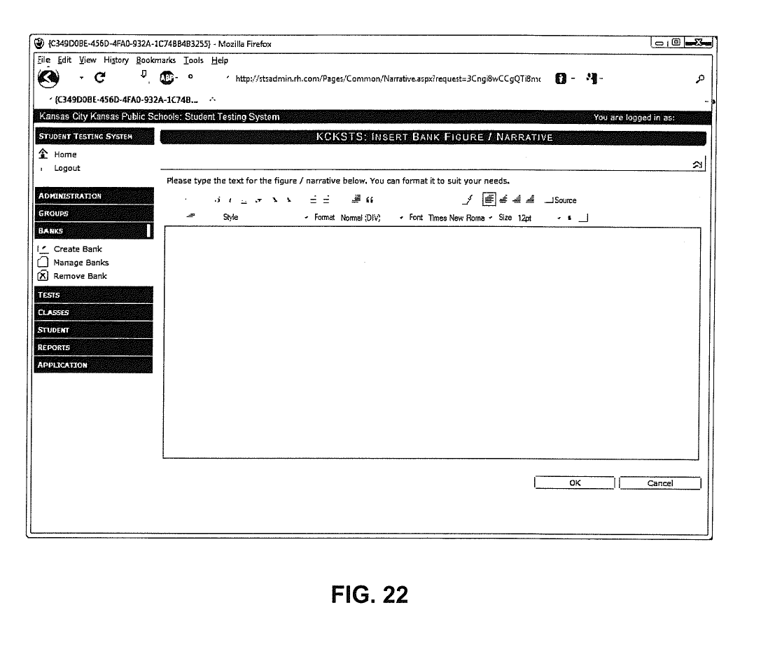

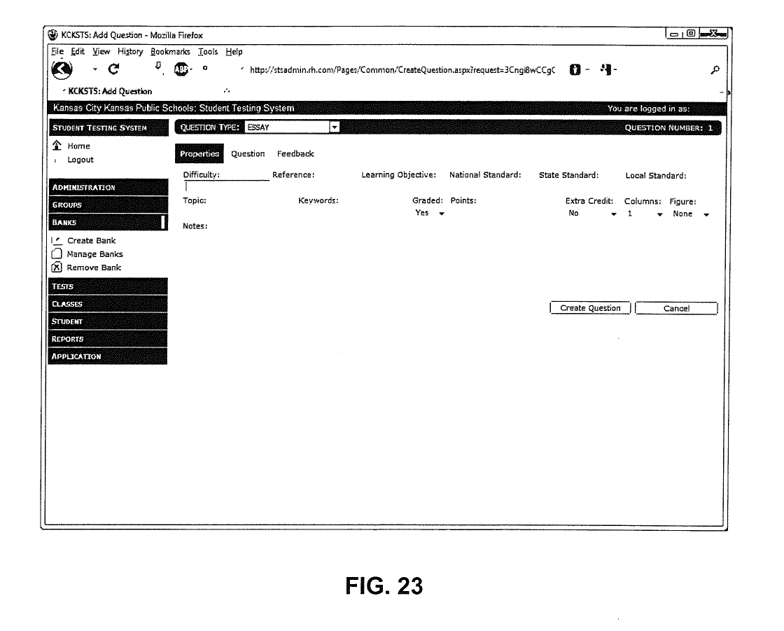

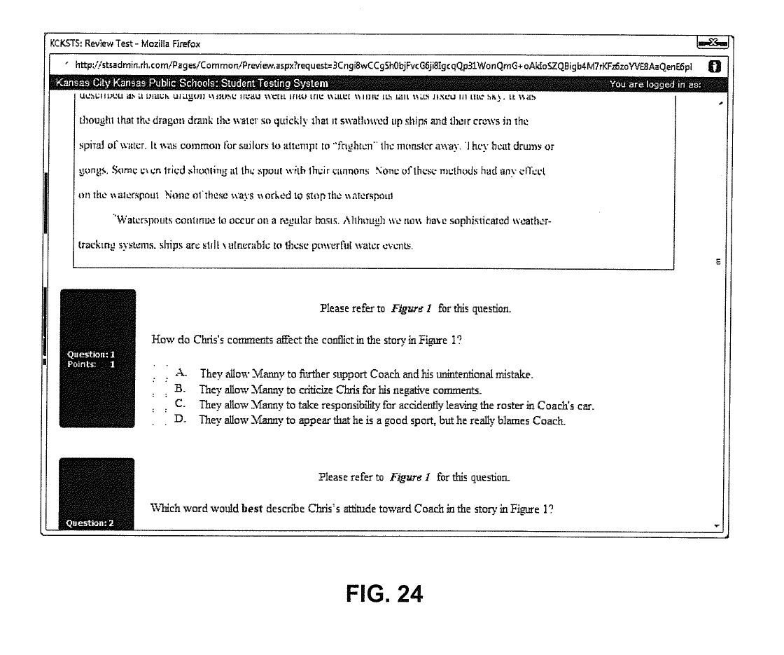

Teachers may create the name and the properties of a bank of questions in the screen of FIG. 20. Teachers may then add images, as shown in FIG. 21, figures, as shown in FIG. 22, and questions, as shown in FIG. 23. A finished bank of questions may be viewed as shown in FIG. 24.

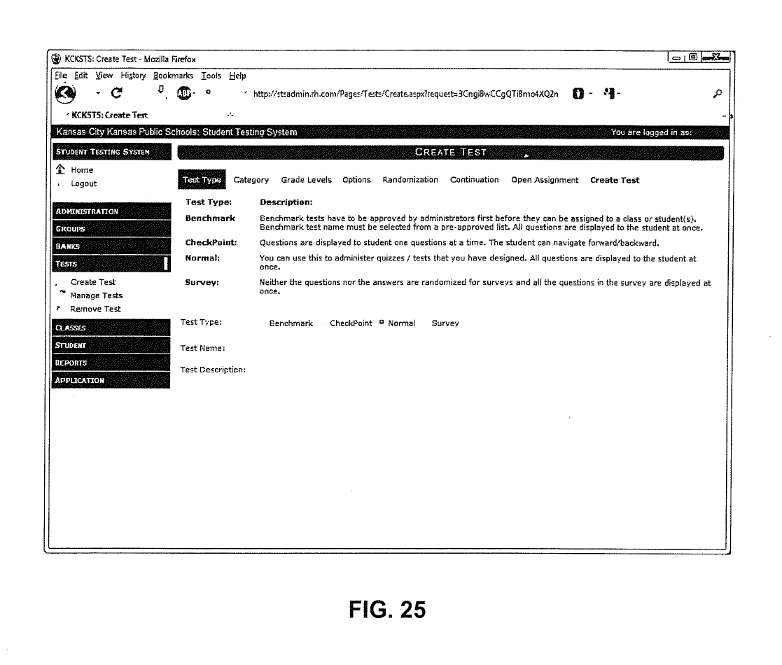

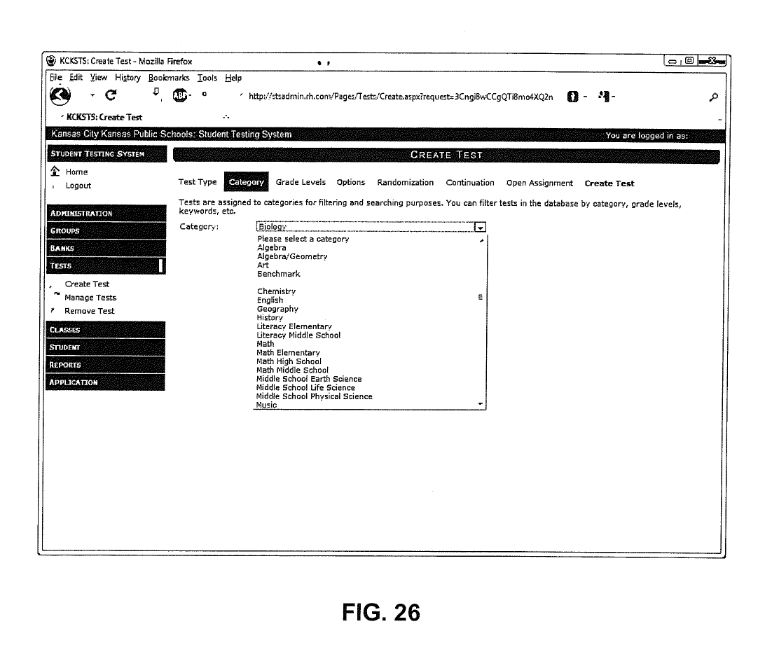

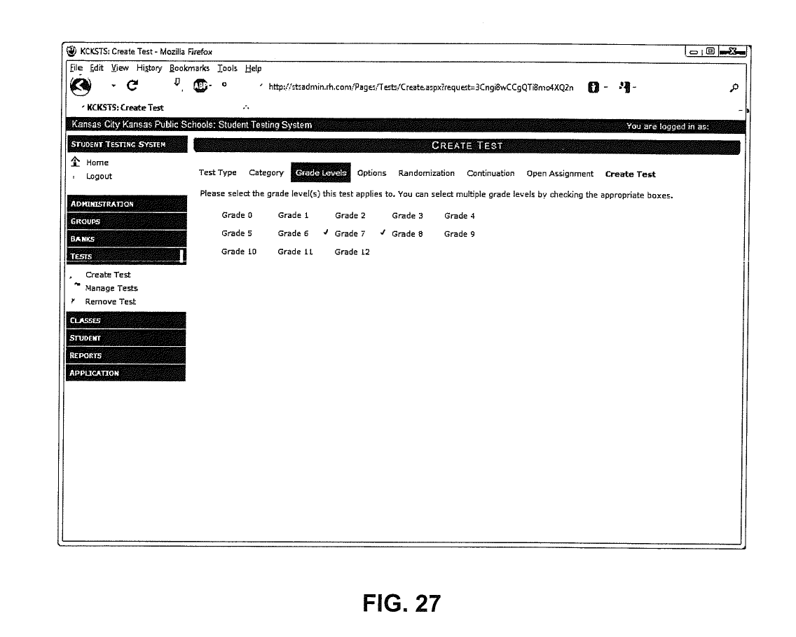

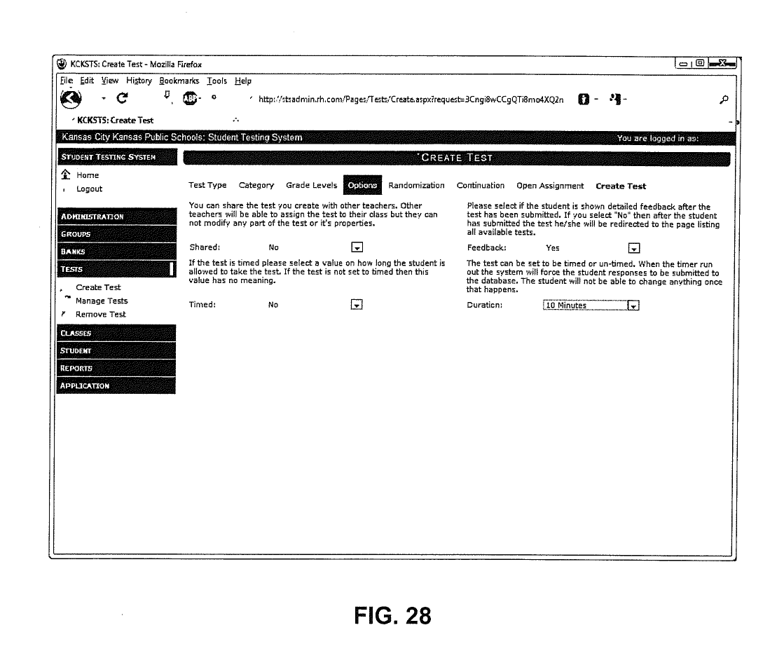

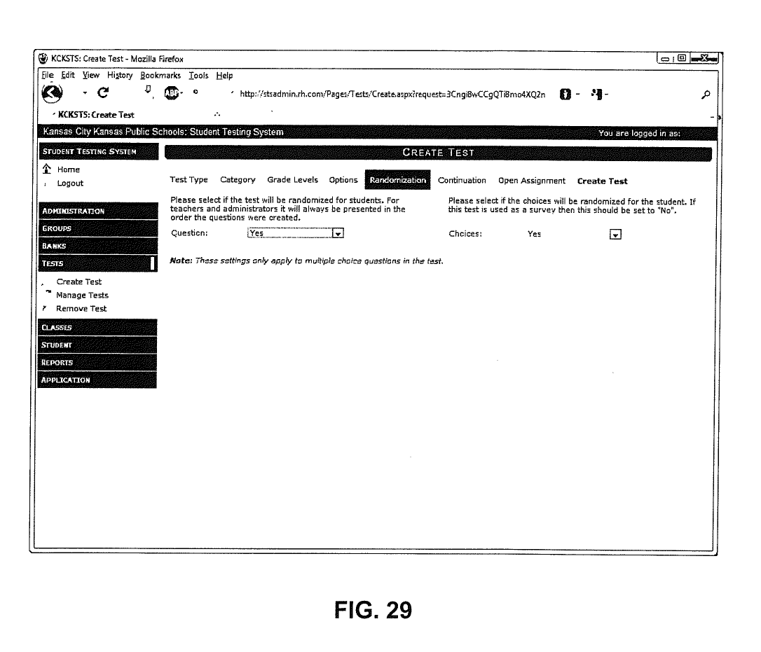

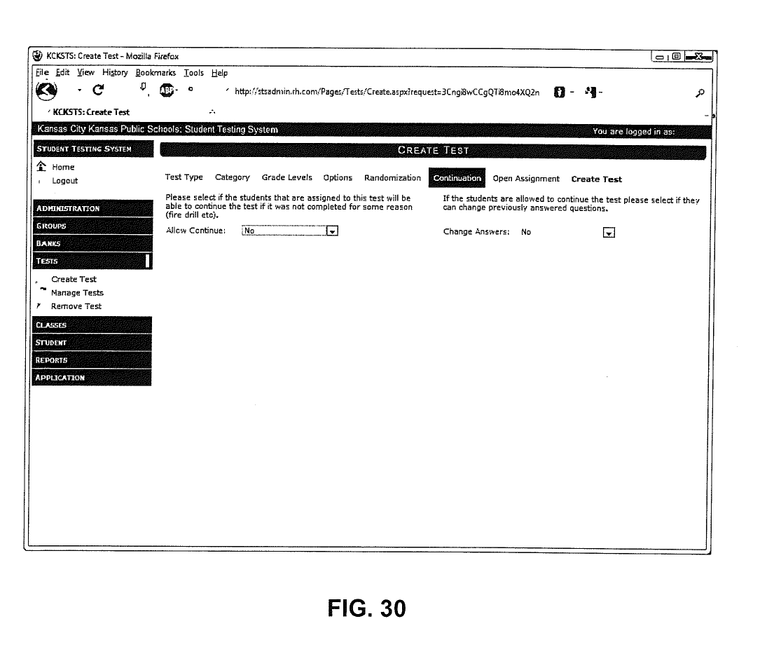

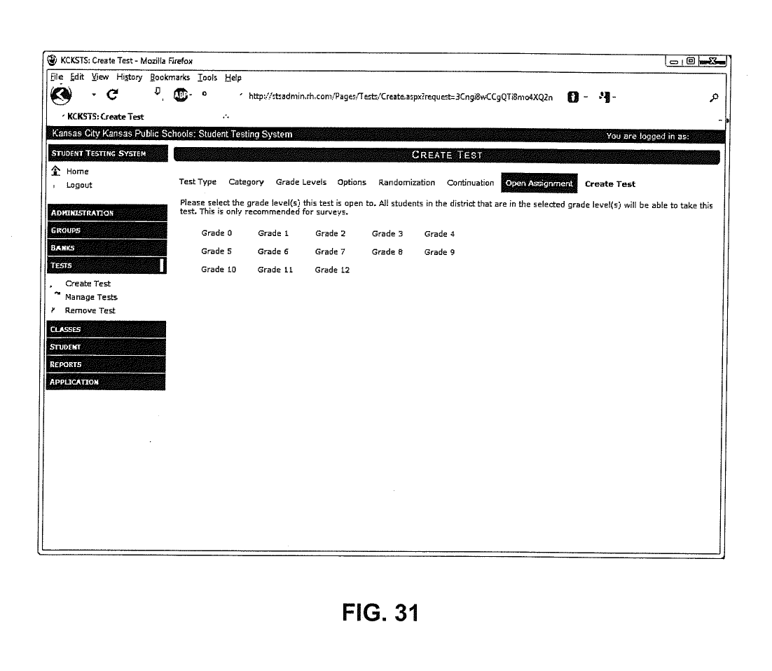

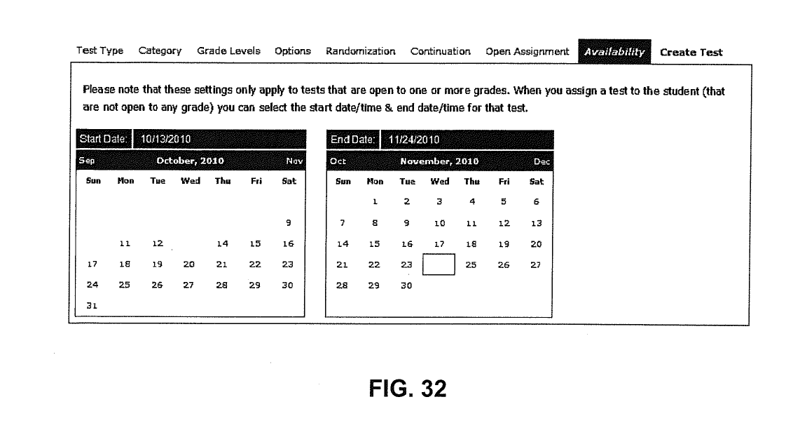

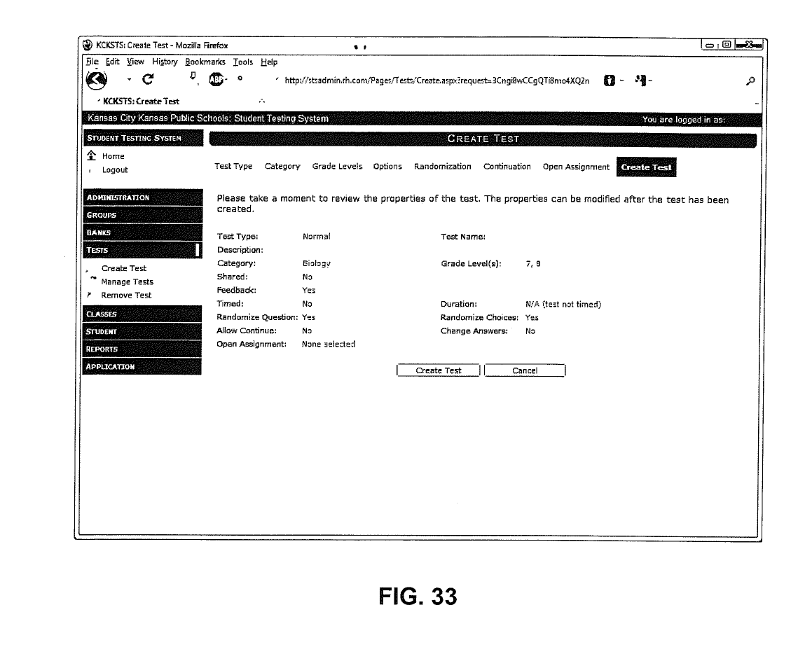

Teachers may create a test by entering the type, name, and description of the test, as shown in FIG. 25. Teachers may also specify various properties of the test, such as a category of the test, as shown in FIG. 26, and the grade levels to which the test applies, as shown in FIG. 27. Various options may be specified in FIG. 28, such as whether the test taker may get feedback after the test is submitted, wherein the test taker may see all of his answers along with the correct answers. Randomization of both the questions and the answers may selected in the screen of FIG. 29. Teachers may allow a continuation of the test if the test was interrupted and may also allow test takers to change the answers to previously-answered questions, as shown in FIG. 30. If the test is to be assigned to all the test takers for a given grade level, then that grade level can be selected in the screen of FIG. 31. The time period during which the test can be taken is assigned in the screen of FIG. 32. All of the properties assigned to a given test may be viewed in the screen of FIG. 33.

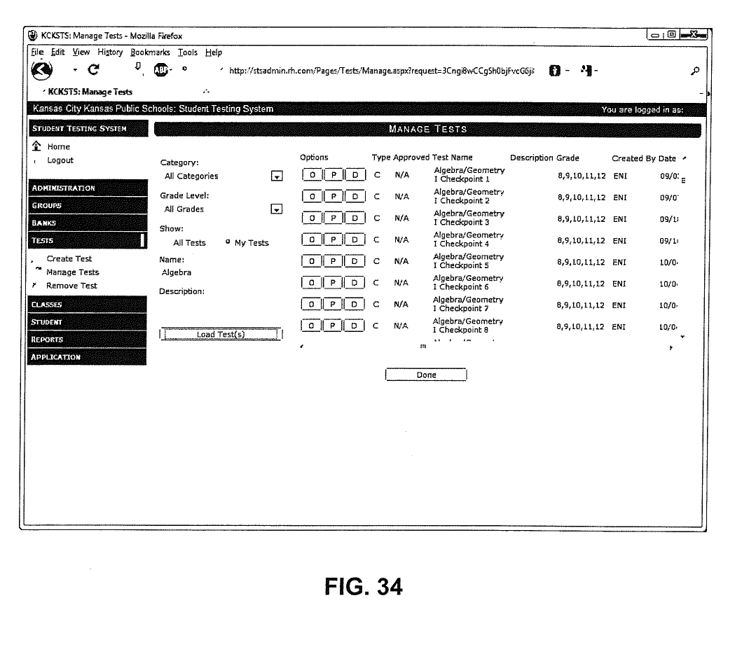

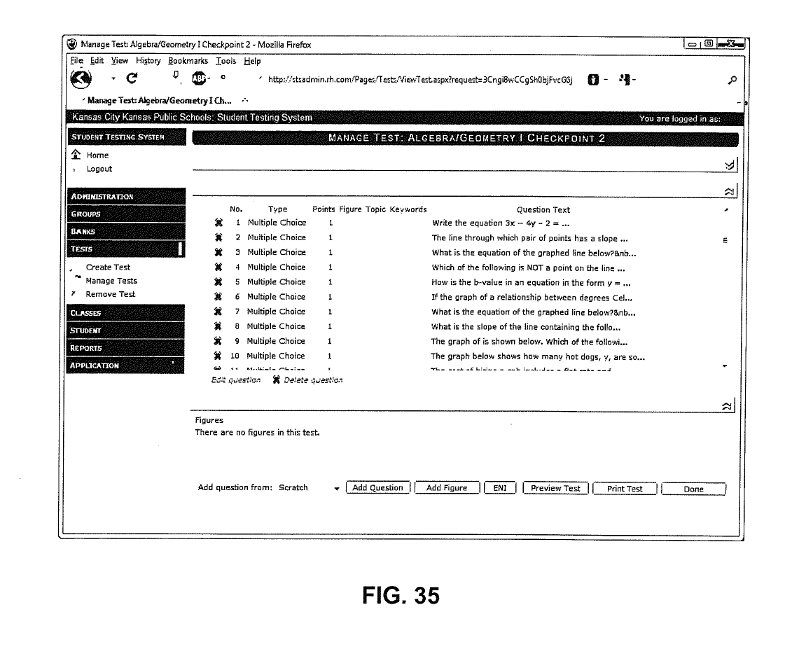

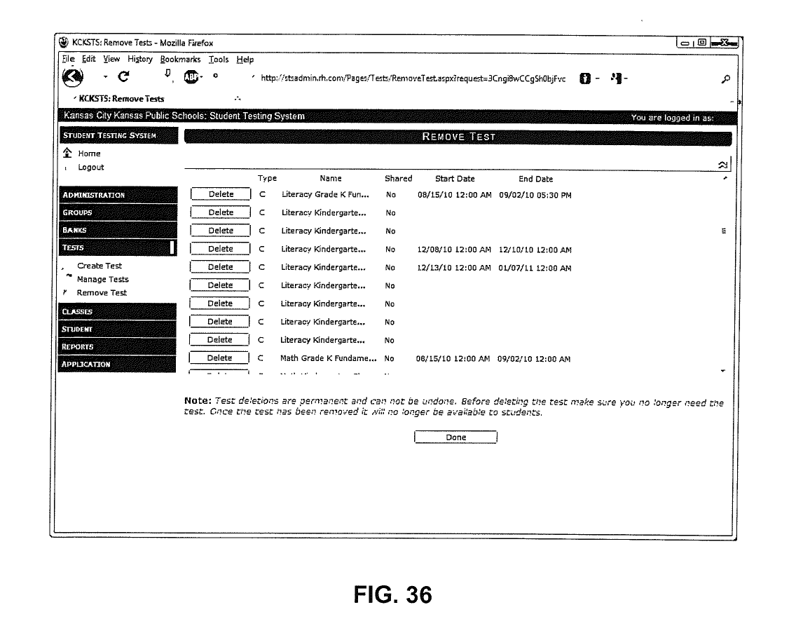

Teachers may manage tests as shown in FIG. 34. There may be options available for each test, such as “O” that opens the test and allows teachers to add, edit, or remove questions from the test, “P” that allows teachers to edit the properties of the test, and “D” that allows a test to be deleted. The questions of an individual test may be managed as shown in FIG. 35. The test may be displayed by selecting “O” from the screen in FIG. 34. Questions may be added, deleted, or edited. Teachers may delete tests from the test storage database 22, as shown in FIG. 36.

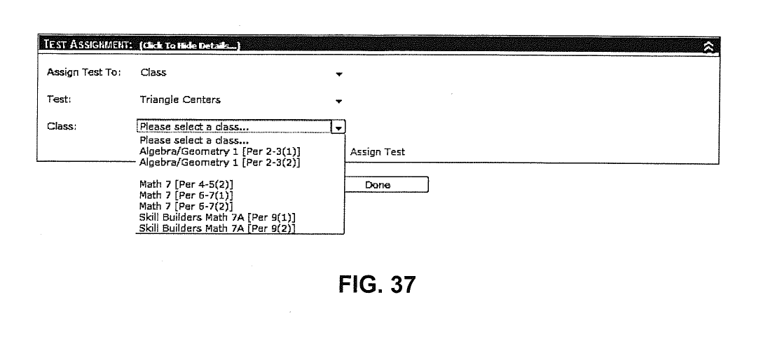

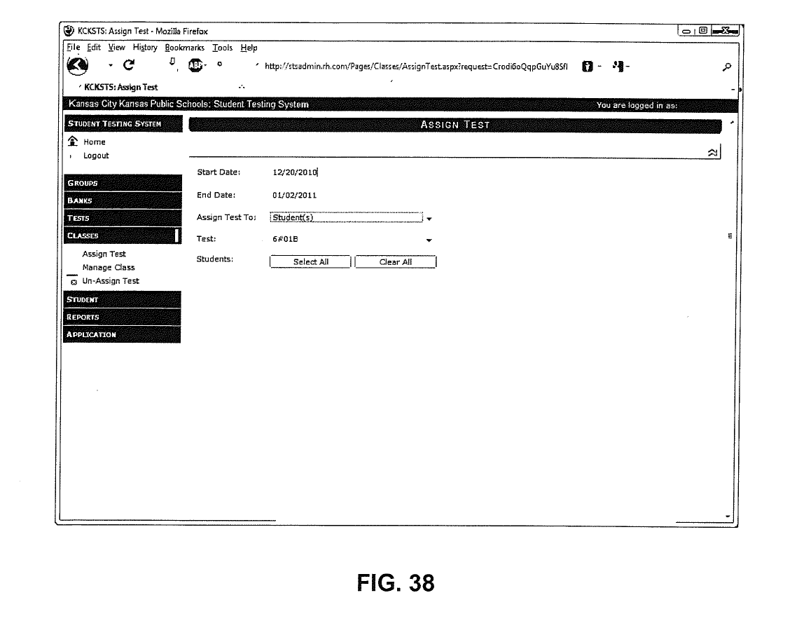

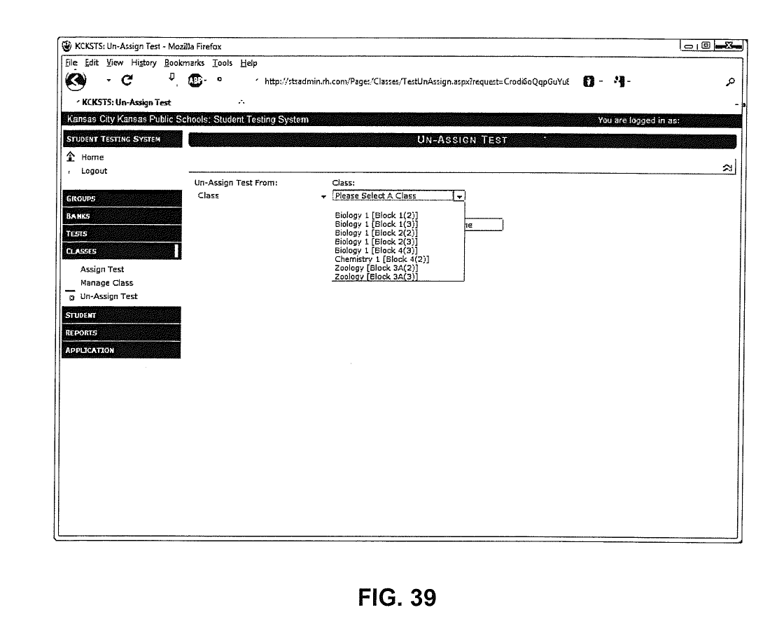

Teachers may assign a test to a group of test takers, as shown in FIG. 37. The group may be a specific class, a grade level, or a specially-created group, such as one created in the screen of FIG. 15. A test may also be assigned to individual test takers, as shown in FIG. 38. If necessary, tests may also be unassigned, as shown in FIG. 39.

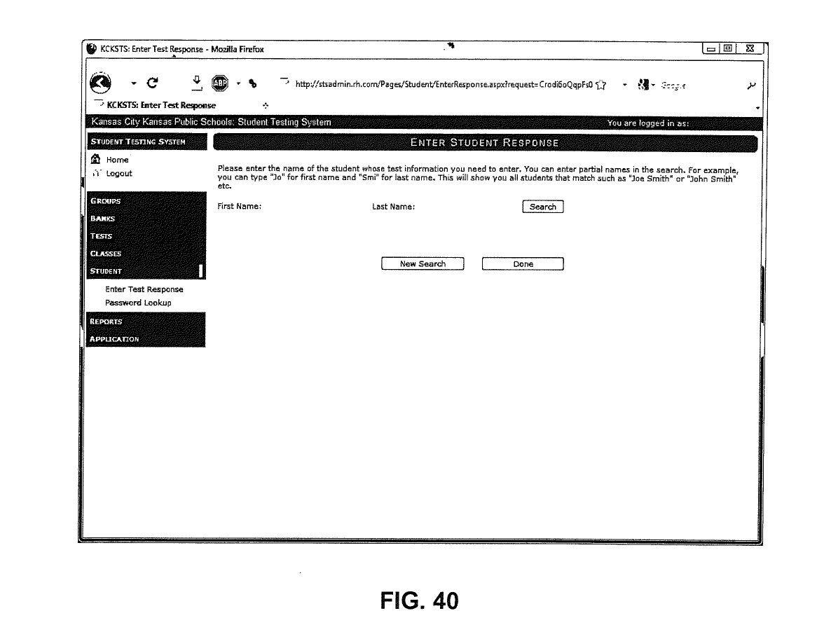

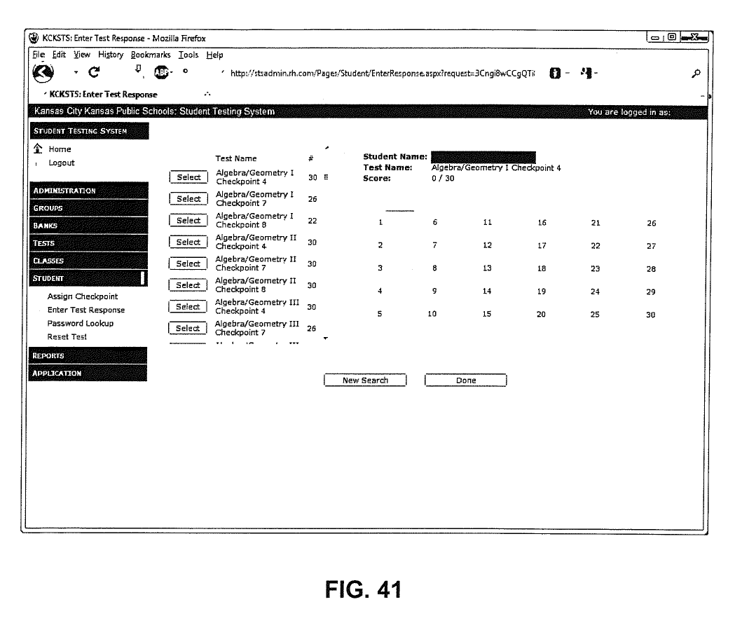

In certain circumstances, test responses may be entered for tests that were administered on paper. Teachers may enter the test taker's name, as shown in FIG. 40, and may enter the response to each question, as shown in FIG. 41.

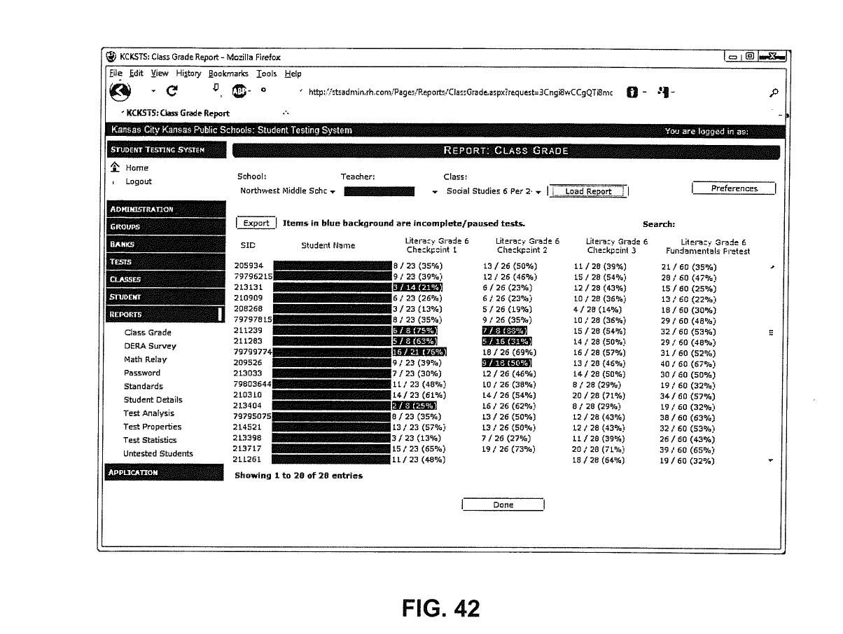

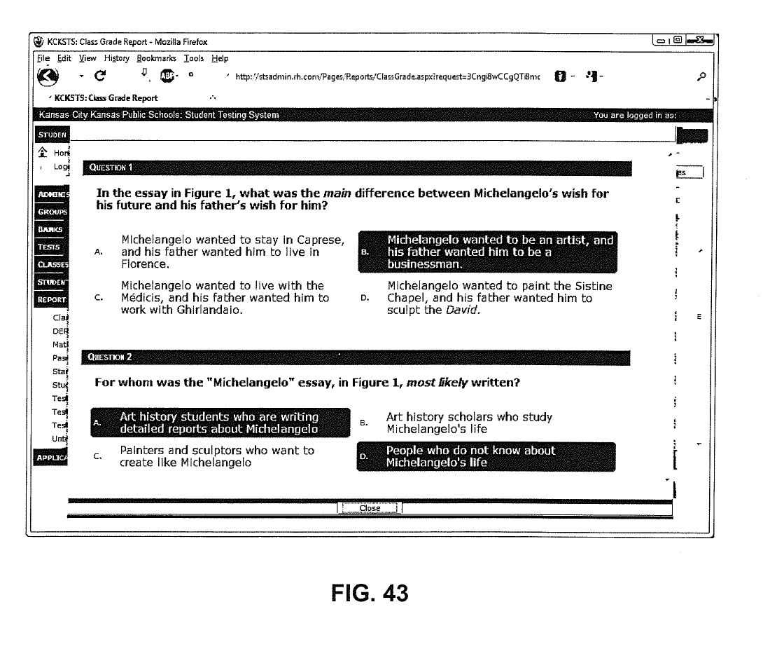

Teachers may view reports of the test results for a group of test takers. For example, teachers may view the test results for a plurality of tests for a given class, as shown in FIG. 42. The results for a given test taker for a given test, as shown in FIG. 43, may be viewed by clicking on the entry for the test in the screen of FIG. 42.

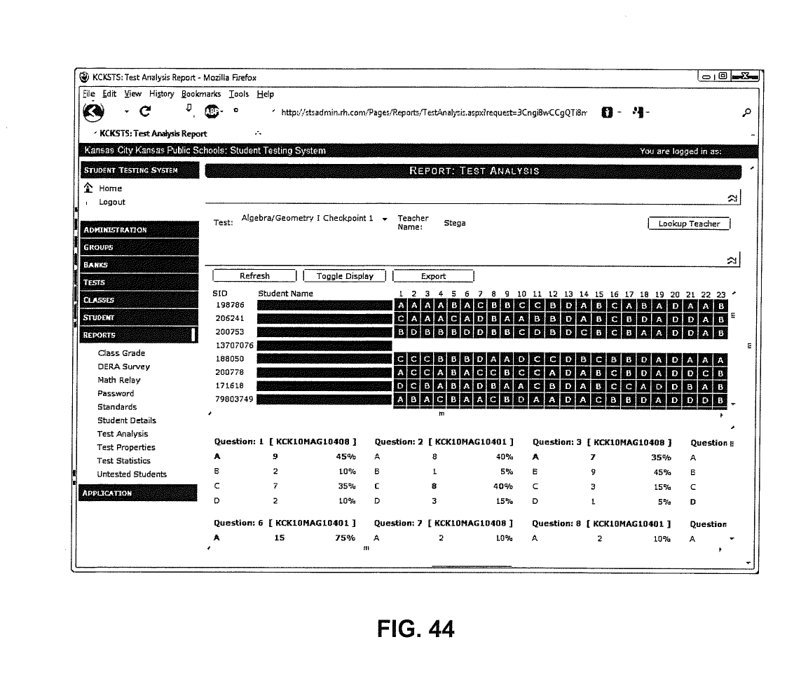

The results of a test currently being administered may be viewed as the answers are submitted, as shown in FIG. 44. The results may be presented as a report that includes the names of all the test takers in a column and the numbers of all the questions in a row with the responses presented in a grid therebetween. A grid space may be the intersection of a row and a column and may include the response from a particular test taker for a particular question. The grid spaces may be filled in with the response as the test taker submits the response. Thus, a row in line with a test taker's name includes the responses to each question from that test taker. A column in line with a question number includes the responses from all the test takers for that question.

The grid spaces may further include an indicia for indicating whether the question has been answered correctly. For example, a first indicia, such as a first color, may indicate that the question has been answered correctly. An exemplary first color may be green. A second indicia, such as a second color, may indicate that the question has been answered incorrectly. An exemplary second color may be red. In addition, there may be a third indicia, such as a third color, for questions that are unanswered. An exemplary third color may be white or black. Thus, the administrator, manager, or teacher that is proctoring the test may be able to spot problems with the test such as not enough time for the test with a lot of unanswered questions, potentially faulty questions that every test taker is answering incorrectly, or situations in which two or more test takers are providing exactly the same responses even when the responses are incorrect.

The report may further include a box for each question that includes the percentage of responses for each possible answer, along with an indicia for the answer that is the correct answer.

The system 10 may operate as follows. A test taker utilizing a computing device 20 with a web browser may use the web browser to request a test taker component 12 from a server 16. The server 16 may return a login screen, as shown in FIG. 2, in which the test taker may enter his user name and password. After verification of the user name and password, the test taker may be presented with a list of all the tests that have been assigned for him to take, as shown in FIG. 3. After choosing a test, the test taker may be presented with the questions of the selected test, as shown in FIG. 4. The test taker may answer the questions as instructed by a proctor or directions embedded in the test. The responses from the test taker are stored in a test results database 24 as soon as the test taker submits them.

In various embodiments, if there is an interruption of the test before all questions have been answered, the test taker may be allowed to complete the test at a later time. In addition, the test taker may also be allowed to change the responses to questions he answered before the interruption. Furthermore, in certain embodiments, the test taker may be able to see the results of the test immediately, if the test creator chose test feedback as an option when creating the test. Thus, the test taker can see his answers as well as the correct answers, as shown in FIG. 5. In other embodiments, if test feedback has not been enabled by the test creator, then the test taker may be returned to the list of tests, shown in FIG. 3, when he has completed a test.

Often, the test taker may take a test utilizing the test taker component 12 in a classroom or examination center setting with a plurality of other test takers taking the same test. However, it is within the scope of the invention for the test taker to take a test utilizing the test taker component in any environment and at any time.

Administrative users, including administrators, managers, and teachers, utilizing a computing device 20 with a web browser may use the web browser to request an administrative component 14 from a server 16. The server 16 may return a login screen, as shown in FIG. 6, in which the administrative user may enter his user name and password. After verification of the user name and password, if the administrative user is an administrator or a manager, he may be presented with the screen shown in FIG. 7. The screen may include a menu option, entitled “ADMINISTRATION”, that includes tasks that only administrators and managers can perform.

As discussed in more detail above, administrators may manage data regarding other administrative users, as shown in FIG. 8, or view and edit local, state, or national standards, as shown in FIG. 9. Administrators and managers may approve benchmark test names, approve the benchmark tests, and manage test categories and news items, as shown in FIGS. 10-13.

If the administrative user is a teacher, he may be presented after login with the screen shown in FIG. 14. Teachers, as well as administrators and managers, may create and manage groups of test takers and create, view, manage, and delete banks of test questions, as shown in FIGS. 15-20. When managing the banks of test questions, teachers may add images, figures, and questions, as shown in FIGS. 21-24, to one or more banks.

Teachers may also create tests, as shown in FIG. 25. When creating a test, teachers may specify the test type, the category, the grade levels to which the test applies, whether the questions and the answers are randomized, whether all the test takers in a given district will be able to take the test, and when the test will be available, as shown in FIGS. 26-27, 29, and 31-32. Teachers may also specify options, as shown in FIG. 28, such as whether the test may be shared, whether the test is timed and the duration for taking the test, and whether the test taker is provided with his responses along with the correct answers after he has completed the test. In addition, as shown in FIG. 30, teachers may specify whether test takers are allowed to complete the test if there is an interruption during the test and whether test takers are allowed to change responses submitted before the interruption. Teachers may view all of the properties for a test in the screen of FIG. 33.

Teachers may view, edit, or delete tests, as well as view, add, edit, or delete questions from individual tests, as shown in FIGS. 34-36. Furthermore, teachers may be able to assign or unassign tests to special groups or individual test takers, as shown in FIGS. 37-39.

When tests are given on paper, teachers may enter the test taker's responses into the test results database 24 by utilizing the administrative component 14. Teachers may enter the test taker's name, as shown in FIG. 40, and may enter the responses to each question, as shown in FIG. 41.

Teachers may view grade reports for all of the tests taken by individual test takers or groups of test takers, as shown in FIG. 42. Teachers may also view test results of an individual test for an individual test taker, as shown in FIG. 43.

Teachers, or any administrative user acting as a proctor, may view the results of a test currently being administered as the answers are submitted, as shown in FIG. 44. The results may be presented as a report that includes the names of all the test takers in a column and the numbers of all the questions in a row with the responses presented in a grid therebetween. A grid space may be the intersection of a row and a column and may include the response from a particular test taker for a particular question. The grid spaces may be filled in with the response as the test taker submits the response. Thus, teachers may be able to check for problems with test questions, or possible copying of answers from one test taker to another.

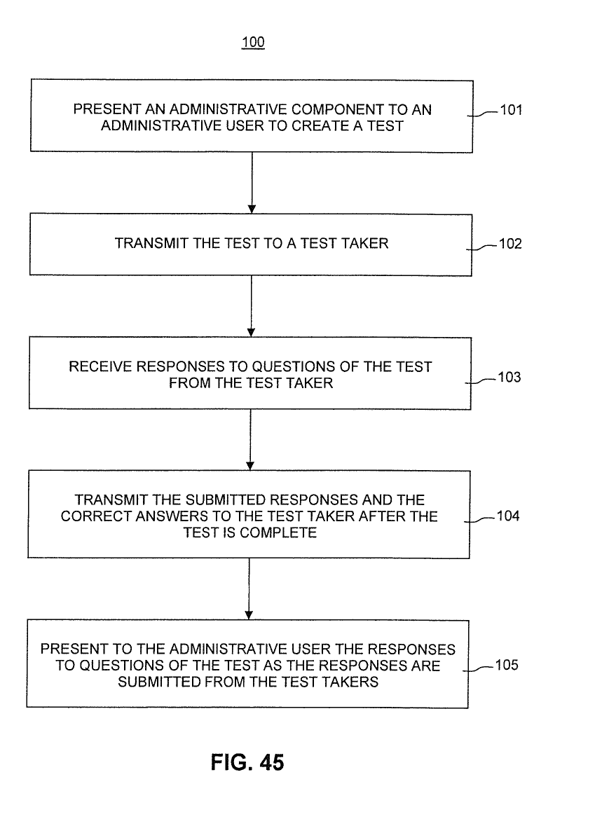

At least a portion of the steps of a method 100 for creating and administering a computer-based test, in accordance with various embodiments of the current invention, is shown in FIG. 45. The steps may be performed in the order as shown in FIG. 45, or they may be performed in a different order. Furthermore, some steps may be performed concurrently as opposed to sequentially. In addition, some steps may be optional.

Referring to step 101, an administrative component 14 is presented to an administrative user to create a test. The administrative user may include an administrator, a manager, or a teacher. The administrative component 14 may be executed in a web browser. The test may be stored in a test storage database 22 that is installed on or accessed by a server 16.

Referring to step 102, the test is transmitted to a test taker. The test may be transmitted from the server 16 through a network connection 18 to a computing device 20, which may be utilized by the test taker. The test taker may operate a web browser which executes a test taker component 12 that allows the test taker to take the test. After receiving the test, the test taker may respond to the test questions.

Referring to step 103, responses to questions of the test are received from the test taker. The responses may be transmitted from the computing device 20 of the test taker through the network connection 18 and may be received by the server 16, wherein the responses may be stored in a test results database 24.

Referring to step 104, the submitted responses and the correct answers are transmitted to the test taker after the test is complete. The test taker may compare his responses to the correct answers in order to receive timely feedback about how well he is learning the tested subject matter.

Referring to step 105, the administrative user is presented responses to questions of the test as the responses are submitted from the test takers. The responses may be presented in a grid such that a name of each test taker is indicated along one axis and a number of each question is indicated along the orthogonal axis. The response from a test taker to a question may be presented in a grid space at the intersection of the name of the test taker and the number of the question. Furthermore, each grid space may include a first indicia for a correct response and a second indicia for an incorrect response.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A system for creating and administering computer-based tests, the system comprising:
a test taker component executed in a web browser and configured to allow a test taker to request a test, to submit responses to questions of the test, and to view the responses and correct answers after the test is complete; and
an administrative component executed in a web browser and configured to allow an administrative user to create the test and to view the responses to questions of the test as the responses are submitted from the test takers.

2. The system of claim 1, wherein the administrative component is further configured to present the responses in a grid such that a name of each test taker is indicated along one axis and a number of each question is indicated along the orthogonal axis.

3. The system of claim 2, wherein the administrative component is further configured to present the response from a test taker to a question in a grid space at the intersection of the name of the test taker and the number of the question.

4. The system of claim 3, wherein the administrative component is further configured to present in each grid space a first indicia for a correct response and a second indicia for an incorrect response.

5. The system of claim 1, wherein the administrative component is further configured to allow the administrative user to enter the responses for the test taker to questions from a paper test.

6. The system of claim 1, wherein the test taker component is further configured to allow the test taker to complete a test that is interrupted before all of the questions have been answered.

7. The system of claim 6, wherein the test taker component is further configured to allow the test taker to change the responses to questions that were answered before the interruption.

8. A method for creating and administering computer-based tests, the method comprising the steps of:
a) presenting an administrative component to an administrative user to create a test;
b) transmitting the test to a test taker;
c) receiving responses to questions of the test from the test taker;
d) transmitting the responses and the correct answers to the test taker after the test is complete; and
e) presenting to the administrative user the responses to questions of the test as the responses are submitted from the test takers.

9. The method of claim 8, further including the step of presenting the responses in a grid such that a name of each test taker is indicated along one axis and a number of each question is indicated along the orthogonal axis.

10. The method of claim 9, further including the step of presenting the response from a test taker to a question in a grid space at the intersection of the name of the test taker and the number of the question.

11. The method of claim 10, further including the step of presenting in each grid space a first indicia for a correct response and a second indicia for an incorrect response.

12. The method of claim 8, further including the step of allowing the administrative user to enter the responses for the test taker to questions from a paper test.

13. The method of claim 8, further including the step of allowing the test taker to complete a test that is interrupted before all of the questions have been answered.

14. The method of claim 13, further including the step of allowing the test taker to change the responses to questions that were answered before the interruption.

15. A non-transitory computer-readable storage medium with an executable program stored thereon for creating and administering computer-based tests, wherein the program instructs a processor to perform the following steps:
a) presenting an administrative component to an administrative user for creating a test;
b) transmitting the test to a test taker;
c) receiving responses to questions of the test from the test taker;
d) transmitting the submitted responses and the correct answers to the test taker after the test is complete; and
e) presenting to an administrative user the responses to questions of the test as the responses are submitted from the test takers.

16. The computer-readable storage medium of claim 15, wherein the program further instructs the processor to present the responses in a grid such that a name of each test taker is indicated along one axis and a number of each question is indicated along the orthogonal axis.

17. The computer-readable storage medium of claim 16, wherein the program further instructs the processor to present the response from a test taker to a question in a grid space at the intersection of the name of the test taker and the number of the question.

18. The computer-readable storage medium of claim 17, wherein the program further instructs the processor to present in each grid space a first indicia for a correct response and a second indicia for an incorrect response.

19. The computer-readable storage medium of claim 15, wherein the program further instructs the processor to allow the administrative user to enter the responses for the test taker to questions from a paper test.

20. The computer-readable storage medium of claim 15, wherein the program further instructs the processor to allow the test taker to complete a test that is interrupted before all of the questions have been answered.

21. The computer-readable storage medium of claim 20, wherein the program further instructs the processor to allow the test taker to change the responses to questions that were answered before the interruption.

22. A system for creating and administering computer-based tests, the system comprising:
a test taker component executed in a web browser and configured to allow a test taker to request a test, to submit responses to questions of the test, to view the responses and correct answers after the test is complete, to complete a test that is interrupted before all of the questions have been answered, and to change the responses to questions that were answered before the interruption; and
an administrative component executed in a web browser and configured to allow an administrative user to create the test, to enter the responses for the test taker to questions from a paper test, and to view the responses to questions of the test as the responses are submitted from the test takers, wherein the administrative component is further configured to present the responses in a grid such that a name of each test taker is indicated along one axis and a number of each question is indicated along the orthogonal axis such that the response from a test taker to a question appears in a grid space at the intersection of the name of the test taker and the number of the question and each grid space includes a first indicia for a correct response and a second indicia for an incorrect response.
